(19) United States
(12) Patent Application Publication
(10) Pub. No.: US 2012/0170254 A1
(43) Pub. Date: Jul. 5, 2012

(54) LIGHT SOURCE LENS, LIGHT SOURCE MODULE HAVING THE SAME AND BACKLIGHT ASSEMBLY HAVING THE LIGHT SOURCE MODULE

(76) Inventors: Prudnikov OLEG, Gyeonggi-do (KR); Young-Chan Kim, Incheon (KR); Byoung-Ho Cheong, Gyeonggi-do (KR)

(21) Appl. No.: 13/152,160

(22) Filed: Jun. 2, 2011

(30) Foreign Application Priority Data
Jan. 4, 2011 (KR) 2011-0000598

(51) Int. Cl. G02F 1/13357; F21V 5/00

(52) U.S. Cl. 362/97.3; 362/326; 362/311.01; 362/311.02; 362/97.1

(57) ABSTRACT

A light source lens includes a refraction surface having a concave portion proximate to a central axis of a light source lens. The central axis passes through a light source that is coupled to the light source lens. An angular distribution function F(θ′) of a first light emitted from the light source and refracted at the refraction surface at least approximately satisfies

$$F ( {θ}^{′} ) ∝ \frac{1}{{cos}^{3} ( {θ}^{′} )} ,$$

where θ′ is a latitude angle of the first light refracted at the refraction surface with respect to the central axis. The lens refracts a light emitted from the light source so that the resulting luminance at the upper area of the light source is more uniform.

### PRIORITY STATEMENT

This application claims priority under 35 U.S.C. §119 to Korean Patent Application No. 2011-598, filed on Jan. 4, 2011 in the Korean Intellectual Property Office (KIPO), the contents of which are herein incorporated by reference in their entireties.

### BACKGROUND

1. Field of the Invention

Example embodiments of the present invention relate generally to flat panel displays. More particularly, example embodiments of the present invention relate to a light source lens, a light source module having the light source lens and a backlight assembly having the light source module.

2. Description of the Related Art

Generally, a liquid crystal display (LCD) operates by selectively altering the arrangement of liquid crystals by applying an electric field to the liquid crystals, thus changing a light transmittance of the liquid crystals to display an image.

The LCD apparatus uses various light sources to display this image. For example, a relatively small-sized LCD apparatus such as a mobile terminal, a digital camera, a multimedia player, etc., typically uses one or more light emitting diodes (LEDs) as its light source. The light guide plates of these apparatuses can be made thinner, or the number of the LEDs made smaller, to decrease thickness, size and cost of these LCD apparatuses.

The LCD apparatus may be classified into edge-illumination type and direct-illumination type displays. In the edge-illumination type display, a light source is disposed at a side of a display panel. In the direct-illumination type display, the light source is disposed directly under the display panel, and a distance between the LED and an upper diffusion plate should be decreased to decrease the total thickness of the LCD apparatus. As the distance between the LED and the upper diffusion plate shrinks, the LED provides more light to the area of the upper diffusion plate under which the LED is disposed. This reduces illuminance uniformity. In addition, when the number of the LEDs is decreased, the distance between the LED and the diffusion plate should be increased to greater than a predetermined distance, or additional diffusion plates may be required to maintain illuminance uniformity. Therefore, reduction in the thickness of LCD apparatuses faces challenges.

### SUMMARY

Example embodiments of the present invention provide a light source lens refracting light so as to generate more uniform luminance above the light source.

Example embodiments of the present invention also provide a light source module having the light source lens.

Example embodiments of the present invention also provide a backlight assembly having the light source module.

According to an example embodiment of the present invention, a light source lens includes a refraction surface having a concave portion proximate to a central axis of a light source lens. The central axis passes through a light source. The light source is coupled to the light source lens. An angular distribution function F(θ′) of a first light emitted from the light source and refracted at the refraction surface within some range of angles at least approximately satisfies

$$F ( {θ}^{′} ) ∝ \frac{1}{{cos}^{3} ( {θ}^{′} )} ,$$

where θ′ is a latitude angle of the first light refracted at the refraction surface with respect to the central axis.

According to another example embodiment of the present invention, a light source module includes a light source and a light source lens. The light source lens includes a refraction surface having a concave portion proximate to a central axis of a light source lens. The central axis passes through the light source. The light source is coupled to the light source lens. An angular distribution function F(θ′) of a first light emitted from the light source and refracted at the refraction surface at least approximately satisfies

$$F ( {θ}^{′} ) ∝ \frac{1}{{cos}^{3} ( {θ}^{′} )} ,$$

where θ′ is a latitude angle of the first light refracted at the refraction surface with respect to the central axis.

In an example embodiment, the light source may include a light emitting diode.

In an example embodiment, a refractive index of the light source lens may be about 1.4.

In an example embodiment, the light source may be disposed on a bottom surface of the light source lens, and an angular distribution function F(θ) of the first light emitted from the light source may at least approximately satisfy

$$F ( θ ) = \frac{cos ( θ )}{π} ,$$

where θ is a latitude angle of the first light emitted from the light source with respect to the central axis.

In an example embodiment, the light source may directly contact the light incident surface.

In an example embodiment, the refraction surface may have a substantially circular shape in a plan view and may be substantially symmetric with respect to the central axis in a cross-sectional view. A first side of the refraction surface may have an arc-shaped curve extending from a lowest position of the concave portion to an edge of the light source lens, with a highest position of the concave portion that is positioned at an angle between about 40° and about 45° with respect to the central axis in the cross-sectional view.

In an example embodiment, a height of the lowest position of the concave portion may be between about 1.7 mm and about 2.0 mm, a height of the highest position of the refraction surface may be between about 2.6 mm and about 2.8 mm, a radius of a circle which is a projection of the refraction surface in the plan view may be between about 4.5 mm and about 5.5 mm, and the first side of the refraction surface may have an arc-shaped curve defined by a plurality of curvature radiuses.

In an example embodiment, the light source may be spaced apart from a bottom surface of the light source lens. An angular distribution function F(θ) of the first light incident into top refraction surface of the light source lens may at least approximately satisfy

$$F ( θ ) = {n}^{2} \frac{cos ( θ )}{π} ,$$

where θ is a latitude angle of the first light emitted from the light source with respect to the central axis and n is a refractive index of the light source lens.

In an example embodiment, the refraction surface may have a substantially circular shape in a plan view and may be substantially symmetric with respect to the central axis in a cross-sectional view. A first side of the refraction surface with respect to the central axis in the cross-sectional view may include an arc-shaped curve extending from a lowest position of the concave portion to a highest position of the concave portion that is positioned at an angle between about 40° and about 45° with respect to the central axis, and a vertical line extending from the arc-shaped curve to an edge of the light source lens. The vertical line may be oriented substantially parallel with the central axis, and positioned at an angle between about 40° and about 50° with respect to the central axis.

In an example embodiment, a height of the lowest position of the concave portion may be between about 3.2 mm and about 3.7 mm, a height of the highest position of the refraction surface may be between about 4.5 mm and about 5.0 mm, and a radius of a circle which is a projection of the refraction surface in the plan view may be between about 4.5 mm and about 5.5 mm.

According to another example embodiment of the present invention, a backlight assembly includes a light source module, one or more optical sheets adjacent to a light source lens and a receiving container. The light source module includes a light source and the light source lens. The receiving container receives the light source, the light source lens and the optical sheets. The light source lens includes a refraction surface having a concave portion proximate to a central axis of the light source lens. The central axis passes through the light source. The light source is coupled to the light source lens. An angular distribution function F(θ′) of a first light emitted from the light source and refracted at the refraction surface at least approximately satisfies

$$F ( {θ}^{′} ) ∝ \frac{1}{{cos}^{3} ( {θ}^{′} )} ,$$

where θ′ is latitude angle of the first light refracted at the refraction surface with respect to the central axis.

In an example embodiment, the light source may include one or more light emitting diodes.

In an example embodiment, the light source and the light source lens may be disposed under the optical sheets.

According to the present invention, the light source lens refracts light emitted from the light source so that the resulting distribution of light (as measured by luminance, illuminance, or other suitable quantity) may be more uniform in the upper area of the light source. Thus, the total thickness of the backlight assembly and the number of its light sources may be reduced.

### BRIEF DESCRIPTION OF THE DRAWINGS

The above and other features and advantages of the present invention will become more apparent by describing in detailed example embodiments thereof with reference to the accompanying drawings, in which:

FIG. 1 is an exploded perspective view illustrating a backlight assembly according to an example embodiment of the present invention;

FIG. 2 is an exploded perspective view illustrating a light source module in FIG. 1;

FIG. 3 is a cross-sectional view explaining a method of defining a shape of a light source lens in the light source module in FIG. 2;

FIG. 4 is a graph illustrating a cross-sectional shape of the light source lens defined by the method in FIG. 3;

FIG. 5 is a cross-sectional view explaining a pathway of light from the light source module in FIG. 2;

FIGS. 6A and 6B are graphs explaining intensity in an upper area of the light source module in FIG. 2;

FIGS. 7A and 7B are graphs explaining the intensity in the upper area of the light source modules when the backlight assembly includes a plurality of the light source modules in FIG. 2;

FIG. 8 is an exploded perspective view illustrating a backlight assembly according to another example embodiment of the present invention;

FIG. 9 is an exploded perspective view illustrating a light source module in FIG. 8;

FIG. 10 is a cross-sectional view explaining a method of defining a shape of a light source lens in the light source module in FIG. 9;

FIG. 11 is a cross-sectional view explaining a pathway of the light from the light source module in FIG. 9;

FIGS. 12A and 12B are graphs explaining intensity in an upper area of the light source module in FIG. 9; and

FIGS. 13A and 13B are graphs explaining the intensity in the upper area of the light source modules when the backlight assembly includes a plurality of the light source modules in FIG. 9.

### DETAILED DESCRIPTION OF EMBODIMENTS OF THE INVENTION

Hereinafter, the present invention will be explained in detail with reference to the accompanying drawings.

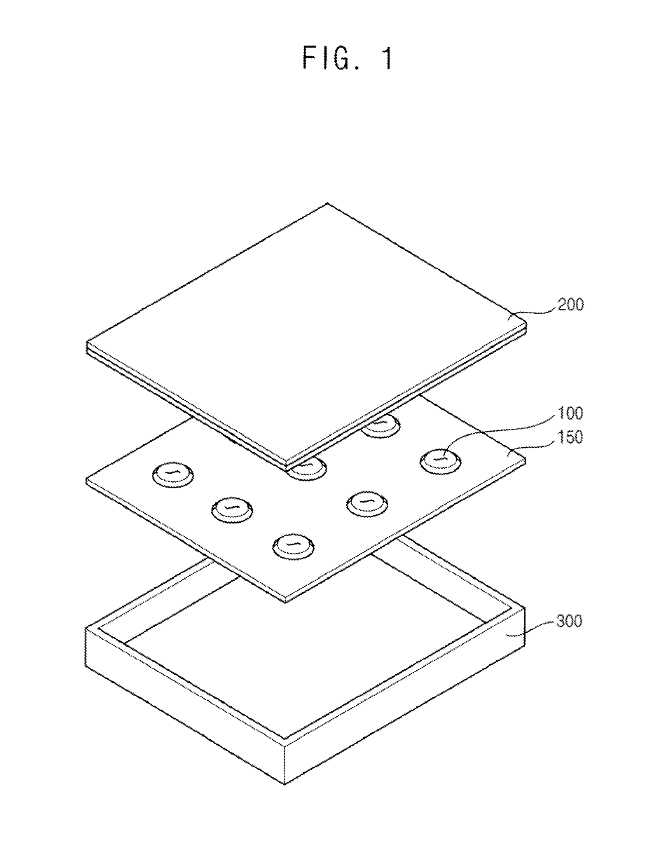

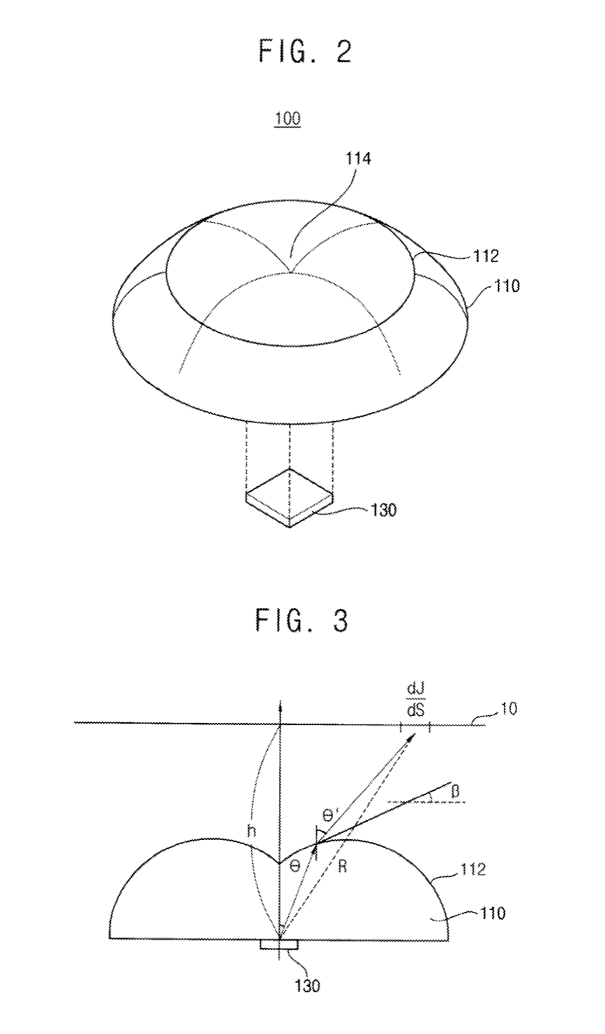

FIG. 1 is an exploded perspective view illustrating a backlight assembly according to an example embodiment of the present invention. FIG. 2 is an exploded perspective view illustrating further details of a light source module of FIG. 1.

Referring to FIGS. 1 and 2, a backlight assembly according to the present embodiment includes a number of light source modules 100, optical sheets 200 and a receiving container 300.

The light source module 100 includes a light source 130 and a light source lens 110 receiving the light source. The light source 130 includes a light emitting diode (LED) which receives power from an external power source, to emit light. The LED can be thought of as a point light source, with the LED generating light that spreads out from one point. For example, the light generated from the LED may be distributed generally in a Lambertian distribution, so that the light may be uniformly distributed in all directions. The LED may be electrically connected to a light source driving film 150 which applies driving power to the LED.

The light source lens 110 includes a refraction surface 112 which has a concave portion 114 at a central axis of the light source lens 110. A light emitted from the light source 130, which is received at a bottom surface of the light source lens, is refracted through the refraction surface 112 and exits from the upper surfaces 112, 114 of the light source lens. Generally, a refractive index of the light source lens 110 is about 1.41.

The backlight assembly may include a plurality of light source modules 100. In order to apply sufficient light to a liquid crystal panel disposed over the backlight assembly, the light source modules 100 may be arranged generally in a matrix pattern at substantially the same distances apart from each other.

The optical sheets 200 are disposed over the light source modules 100. The optical sheets include a plurality of sheets, and improve luminance characteristics of the light emitted from the light source 130.

Here, the receiving container 300 has a quadrangle frame shape, with the light source module 100 and the optical sheets 200 being received and fixed in the receiving container. However, embodiments of the invention contemplate any shape and arrangement of these elements.

Hereinafter, the light source module 100 will be explained in further detail.

The light source module 100 includes the light source 130 and the light source lens 110. The light source 130 is received by a bottom surface of the light source lens 110, at the central axis of the light source lens 110. The light source 130 is disposed on the bottom surface of the light source lens 110. For example, a light incident surface formed on the bottom surface of the light source lens 110 has a shape substantially the same as the shape of the light source 130, so that the light source 130 is completely adhered to the light incident surface of the light source lens 110. That is, the bottom surface of the light source lens 110 has a depression shaped to accommodate the light source. 130 Therefore, the light source 130 directly contacts the light source lens 110 (i.e., is coupled to the light source lens so that substantially no space exists between the light source 130 and the light source lens 110), and the light emitted from the light source 130 advances into the light source lens 110 substantially without refraction. The light emitted from the light source 130 passes through the light source lens 110, and then is refracted through the refraction surface 112 of the light source lens 110. The refracted light passes through the optical sheets 200 disposed over the light source lens 110, and then is applied to the liquid crystal panel (not illustrated) disposed over the optical sheets 200.

If the light source lens 110 were not present, due to the Lambertian distribution of the light emitted from the light source 130, the intensity of the light reaching a bottom surface of the optical sheets 200 is the largest on an area substantially perpendicular to the light source 130, i.e. directly above each light source. Therefore, the luminance of an image displayed on the liquid crystal panel is not uniform. In order to improve luminance uniformity, a shape of the light source lens receiving the light source is optimized to diffuse the light, and/or a diffusion sheet is included in the optical sheets. Alternatively (or additionally), in order to improve the luminance uniformity, a distance between the optical sheets and the light source is controlled, or the number of light sources is increased.

In the present example embodiment, the light source lens 110 receiving the light source includes the refraction surface 112 which has the concave portion 114 at the central axis of the light source lens 110, so that the intensity of the light emitted from the light source lens 110 is more uniformly distributed across the bottom surface of the optical sheets 200.

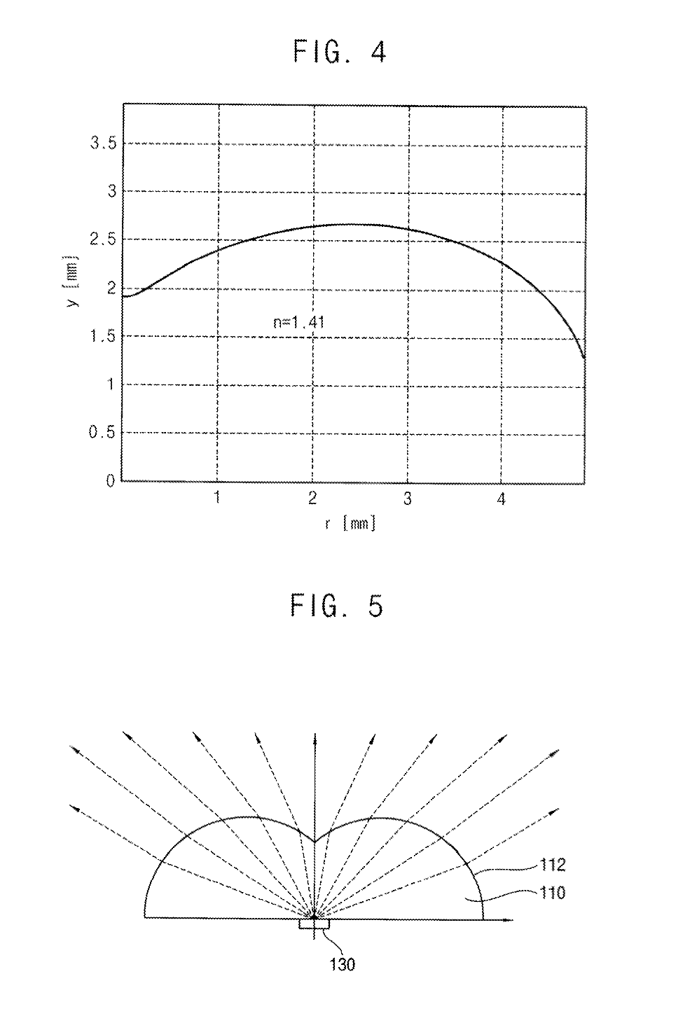

A method for forming a shape of the refraction surface 112 of the light source lens 110 will be explained in detail referring to FIGS. 3 and 4.

FIG. 3 is a cross-sectional view explaining a method of defining a shape of a light source lens in the light source module 100 of FIG. 2. FIG. 4 is a graph illustrating a cross-sectional shape of the light source lens defined by the method of FIG. 3.

Referring to FIGS. 3 and 4, the light emitted from the light source 130 is refracted on the refraction surface 112 of the light source lens 110, where it travels to the bottom surface 10 of the optical sheets 200 that are disposed over the light source module 100. When a first angle of a first light emitted from the light source 130 with respect to the central axis of the light source lens is θ and a second angle of the first light refracted on the refraction surface 112 with respect to the central axis is θ′, a luminous intensity J of a very small amount of area dS on the bottom surface 10 of the optical sheets may be expressed by Equation 1.

$$\frac{d J}{d S} = {J}_{0} \frac{cos ( {θ}^{′} )}{{R}^{2}} F ( {θ}^{′} ) \qquad [ Equation 1 ]$$

In Equation 1, J₀ is a luminous intensity of the light source, R is a distance between the light source 130 and area dS of the bottom surface 10, and F(θ′) is an angular distribution of the first light refracted on the refraction surface 112.

When the bottom surface 10 receives light of uniform luminance, the luminous intensity J of the very small area dS should be a constant. When the luminous intensity J of the very small area dS is a constant. F(θ′) may be expressed by Equation 2.

$$F ( {θ}^{′} ) = const \frac{{h}^{2}}{{J}_{0}} \frac{1}{{cos}^{3} ( {θ}^{′} )} \qquad [ Equation 2 ]$$

In Equation 2, h is a vertical distance between the light source and the bottom surface 10 of the optical sheets.

Therefore, when F(θ′) is proportional to 1/cos³(θ′), the intensity of the light on the bottom surface 10 disposed over the light source is uniform.

When the light generated from the light source 130 has a Lambertian distribution, a distribution function of the light source 130 as a function of θ may be expressed by Equation 3.

$$F ( θ ) = \frac{cos ( θ )}{π} \qquad [ Equation 3 ]$$

Therefore, when light having the angular distribution function of Equation 3 is refracted through the refraction surface 112 of the light source lens 110 to have the angular distribution function of Equation 2, the intensity of the light directed on the bottom surface 10 is uniform. Using Equations 1 through 3, the relation between θ and θ′ may be expressed by the following Equation 4 and Equation 5.

$$\begin{matrix}const = \frac{d J}{d S} = \frac{{cos}^{3} ( {θ}^{′} )}{2 π {h}^{2} sin ( {θ}^{′} )} \frac{d J}{d {θ}^{′}} = \frac{{cos}^{3} ( {θ}^{′} )}{2 π {h}^{2} sin ( {θ}^{′} )} \frac{d J}{d θ} \frac{d θ}{d {θ}^{′}} & [ Equation 4 ] \\ \frac{d J}{d θ} = 2 π sin ( θ ) F ( θ ) & [ Equation 5 ]\end{matrix}$$

The light emitted from the light source 130 is refracted through the refraction surface 112 of the light source lens 110. Therefore, when an angle between a tangent line of the refraction surface 112 and a horizontal line is β, β(θ) may be expressed by Equation 6, from Snell's law.

n sin(θ+β)=sin(θ′+β) [Equation 6]

In Equation 6, n is a refractive index of the light source lens.

(β(θ) may be solved using the above Equations, for values of θ in a range of 0°<θ<90°. Therefore, a first side of the refraction surface 112 with respect to the central axis of the light source lens 110 may be defined in a cross-sectional view, as illustrated in FIG. 4.

Referring to FIGS. 2 and 4 again, the refraction surface 112 of the light source lens 110 has a substantially circular shape in a plan view. The light source lens 110 is symmetric with respect to the central axis in a cross-sectional view. In cross-sectional view of the light source lens 110, the shape of one side of the refraction surface 112 with respect to the central axis has an arc-shaped curve which extends from a lowest position of the concave portion 114 to an edge of the light source lens 110. The arc-shaped curve has a highest position at an angle between about 40° and about 45° with respect to the central axis. A radius of the arc-shaped curve extending from the concave portion to the highest position is smaller than a radius of the arc-shaped curve extending from the highest position to the edge of the light source lens 110.

For example, a height of the lowest position of the concave portion 114 (i.e., along the vertical line of FIG. 3) is between about 1.7 mm and about 2.0 mm, a height of the highest position of the refraction surface 112 is between about 2.6 mm and about 2.8 mm, and the outer radius of the refraction surface 112 in a plan view is between about 4.5 mm and about 5.5 mm. Since the light source lens 110 has the above-mentioned shape, the light refracted through the refraction surface of the light source lens 110 satisfies Equation 2. Therefore, the light refracted through the refraction surface 112 has substantially uniform angular distribution in the upper area of the light source lens 110.

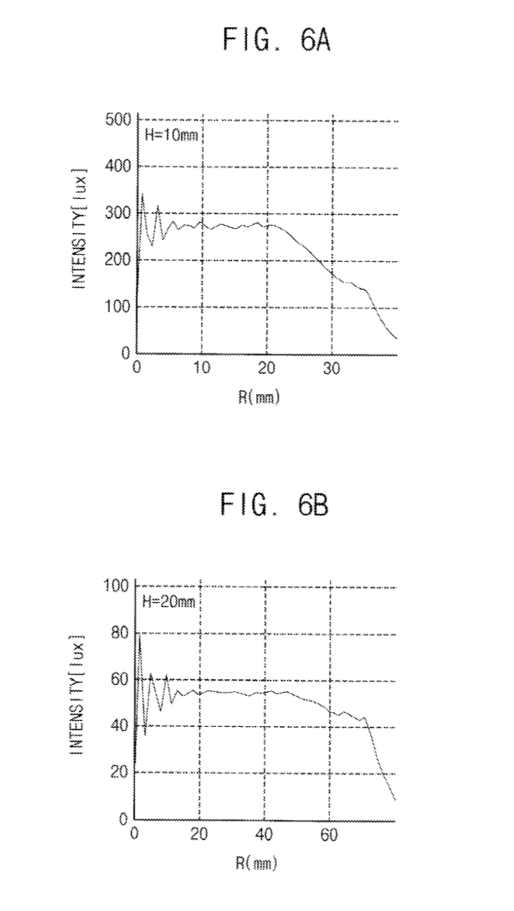

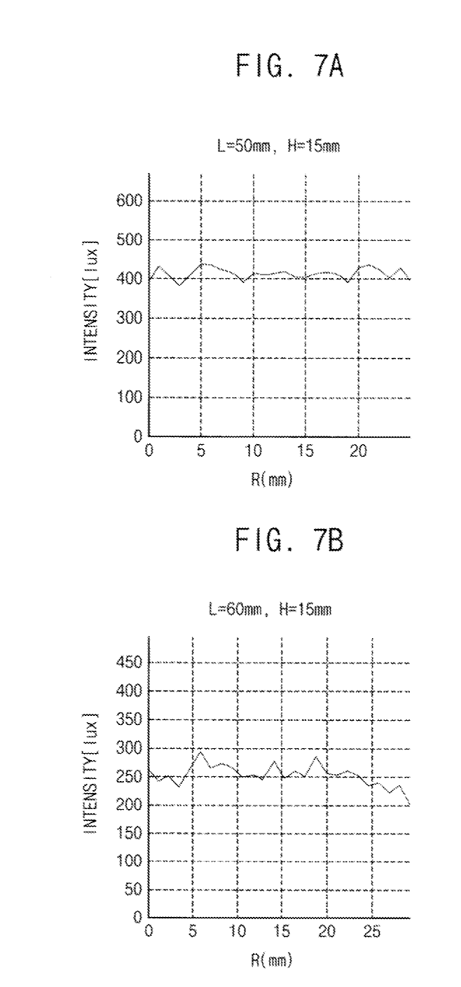

FIG. 5 is a cross-sectional view explaining a pathway of light from the light source module of FIG. 2. FIGS. 6A and 613 are graphs explaining illuminance of an upper area of the light source module of FIG. 2. FIGS. 7A and 7B are graphs explaining illuminance of the upper area of the light source modules 100 when the backlight assembly includes a plurality of the light source modules 100 of FIG. 2.

Referring to FIG. 5, the light at the central axis of the light source lens 110 passes upward without refraction. As an angle of the light with respect to the central axis of the light source lens 110 grows larger, the light is refracted at the refraction surface 112 of the light source lens 110 so as to be spread out, or dispersed. Therefore, the light has substantially uniform angular distribution in upper area of the light source lens 110.

Referring to FIGS. 6A and 6B, a distribution of illuminance at distance R from the central axis of the light source lens 110 and at vertical distance H from the light source 130 is shown. When the vertical distance H from the light source 130 is about 10 mm, the distribution of the luminous intensity is approximately uniform for R values between about 0 mm and about 20 mm. When the vertical distance H from the light source 130 is about 20 mm, the absolute value of the luminous intensity is approximately uniform between about 0 mm and about 60 mm.

Accordingly, the light source 130 exhibits approximately uniform illuminance over a range of R values, even if the distance between the optical sheets 200 and light source 130 is decreased. Therefore, substantially uniform illuminance may more effectively be maintained, while also decreasing the total thickness of the backlight assembly. In addition, it can be seen that the backlight assembly may maintain approximately uniform illuminance without a diffusion sheet, so that the optical sheets 200 need not necessarily include a diffusion sheet, thus further reducing the total thickness of the backlight assembly.

Referring to FIGS. 1, 7A and 7B, the backlight assembly may include a plurality of the light source modules 100. In this case, the light emitted from each of the light sources overlaps above the light sources 130, so that illuminance in the upper area of the light sources may be affected by the number of light sources 130. In the present example embodiment, the backlight assembly includes a plurality of the light source modules 100, and a distribution of the luminous intensity according to a distance R from the central axis of the light source lens 110 is approximately uniform in an area which is disposed over the light source 130 by a vertical distance H. It follows that, even if a distance between adjacent light source modules 100 is increased, or the number of the light source modules 100 is decreased, the overall illuminance may remain approximately uniform. In FIGS. 7A and 78, L is a distance between adjacent light source modules 100. When the distance between the light source modules 100 increases from about 50 mm to about 60 mm, the absolute value of illuminance or luminous intensity is decreased, but the distribution of illuminance remains substantially uniform.

As illuminance may be kept substantially uniform with a reduced number of light sources included in the backlight assembly, the total thickness of the backlight assembly may thus be decreased.

It should be noted that the light source modules of the invention need not satisfy the above equations exactly. In particular, light source modules whose various surfaces only approximately satisfy the above equations will achieve approximately the same results as above. Furthermore, light generated from the light source 130 is distributed in a Lambertian distribution as mentioned above, but the invention is not limited thereto. The light generated from a light source may be distributed in any other manner, such as in a Gaussian distribution or some other. In this case, F(θ) is replaced with a different function of angular distribution of the light source (e.g., a Gaussian distribution or the like), and then the above-mentioned Equations may be used in the same way as mentioned above. For example, Equation 3 may be replaced with a Gaussian distribution function of θ.

Accordingly, whatever angular distribution the light source has, the angular distribution of the light exiting from the light source lens may satisfy Equation 2, so that the shape of the light source lens may be determined. For example, using Equations 1 to 6, the shape of the light source lens is formed so that the angular distribution of the light exiting from the light source lens satisfies Equation 2. The resulting light source lens would thus produce substantially uniform illuminance above its light source.

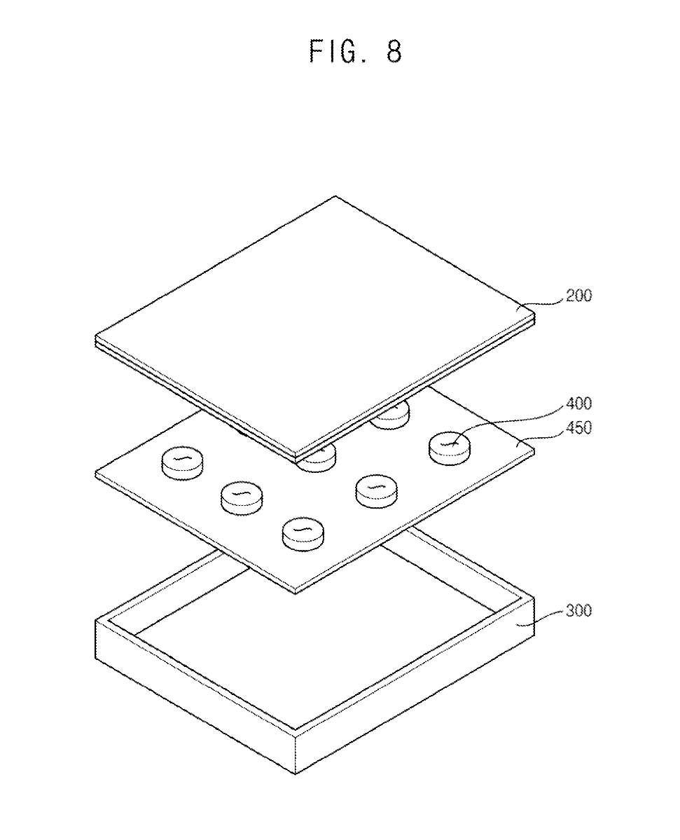

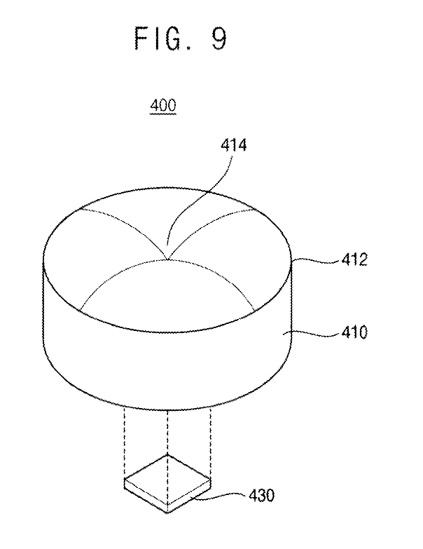

FIG. 8 is an exploded perspective view illustrating a backlight assembly according to another example embodiment of the present invention. FIG. 9 is an exploded perspective view illustrating a light source module of FIG. 8. The backlight assembly according to the present example embodiment is substantially the same as the backlight assembly of the embodiment of FIG. 1, except for the light source modules. Therefore, the same reference numerals will be used to refer to the same or like parts as those described in the previous example embodiment, and any further repetitive explanations concerning the same or similar elements is largely omitted.

Referring to FIGS. 8 and 9, the backlight assembly includes a light source module 400, optical sheets 200 and a receiving container 300.

The light source module 400 includes a light source 430, and a light source lens 410 receiving the light source 430. The light source 430 includes a light emitting diode (LED) which emits light when supplied with power from an external source. The LED may be electrically connected to a light source driving film 450 which applies a driving power to the LED.

The light source lens 410 includes a refraction surface 412 which has a concave portion 414 near its central axis. Light emitted from the light source 430 received in a bottom surface of the light source lens 410 is refracted through the refraction surface 412, and exits from an upper area of the light source lens 410. Our results were obtained for the lenses with refractive index 1.41. Generally the other materials with the other refractive index can be used.

The light source module 400 includes the light source 430 and the light source lens 410. The light source 430 is received in the bottom surface of the light source lens 410, centered at the central axis of the light source lens 410. The light source 430 is positioned at a predetermined distance from the bottom surface of the light source lens 410. For example, the light source 430 is separated from the bottom surface of the light source lens 410 by a relatively small distance. Therefore, a small space between the light source 430 and the light incident surface of the light source lens 410 is formed, so that light emitted from the light source 430 passes through this small space, and then falls incident to the light source lens 410. In this case, the light emitted from the light source 430 is first refracted through the light incident surface of the light source lens 410, and is then refracted through the refraction surface 412 of the light source lens 410. The refracted light passes through the optical sheets 200 disposed over the light source lens to have improved luminance and improved optical characteristics, and then illuminates a liquid crystal panel (not shown) disposed over the optical sheets 200.

The light source lens 410 receiving the light source 430 includes a refraction surface 412 which has a concave portion 414 near a central axis of the light source lens 410, so that the intensity of the light emitted from the light source lens 410 is more uniformly distributed across the bottom surface of the optical sheets 200 disposed over the light source module 100. A method of forming a shape of the refraction surface 412 is substantially the same as the method of the previous example embodiment explained in FIGS. 3 and 4. However, in the light source module 400, light source 430 is spaced apart from the light incident surface of the light source lens 410 by a small distance, so that the light emitted form the light source 430 is refracted through the light incident surface of the light source lens 410 and is then refracted through the refraction surface 412 of the light source lens. The angular distribution of the light incident to the light source lens 410 depends on the refractive index of the light source lens 410, and may be expressed by Equation 7.

$$F ( θ ) = \{ \begin{matrix}{n}^{2} \frac{cos ( θ )}{π} , & ( θ \leq {θ}_{c} ) \\ 0 , & ( θ > {θ}_{c} )\end{matrix} \qquad [ Equation 7 ]$$

In Equation 7, n is the refractive index of the light source lens 410, and θ_{c} is a total reflection angle of the light that passes through the light source module 400.

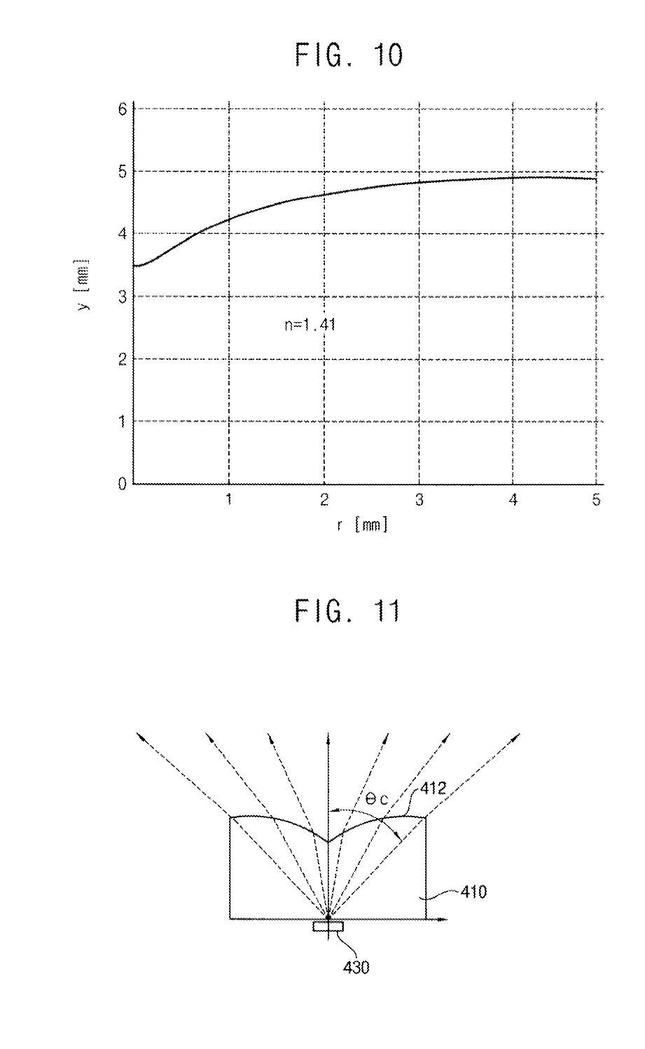

Therefore, in Equation 5, we can use angular distribution function defined by Equation 7, thus the slope of the lens top refraction surface β(θ) may be calculated using Equations 4 to 6, and then β may be solved according to θ for 0<θ<θc. The resulting cross-sectional shape of a first side of the refraction surface 412 with respect to the central axis of the light source lens 410 is as illustrated in FIG. 10.

FIG. 10 is a cross-sectional view explaining a method of defining a shape of a light source lens in the light source module 400 of FIG. 9.

Referring to FIGS. 9 and 10, the refraction surface 412 of the light source lens 410 has a substantially circular shape in a plan view, and is symmetric with respect to the central axis in a cross-sectional view. In a cross-sectional view of the light source lens 410, the shape of the first side of the refraction surface 412 with respect to the central axis includes an arc-shape curve and a vertical line. The arc-shape curve extends from the inner concave portion, and the vertical line extends from the arc-shape curve to form an edge of the light source lens 410. The vertical line is substantially parallel to the central axis. The arc-shape curve extends from a lowest position of the concave portion (near the central axis) to a position at an angle between about 40° and about 50° with respect to the central axis, and the arc-shape curve has a highest position at an angle between about 40° and about 45° with respect to the central axis (near r=4 mm in the graph of FIG. 10). The vertical line extends from an edge of the arc-shape curve to the bottom surface of the light source lens 410.

As one example, a height of the lowest position of the concave portion 414 is between about 3.2 min and about 3.7 mm, a height of the highest position of the refraction surface 412 is between about 4.5 mm and about 5.0 mm, and a radius of a circle which is a projection of the refraction surface 412 in the plan view is between about 4.5 mm and about 5.5 mm. Since the light source lens has the above-mentioned shape, the light refracted through the refraction surface 412 of the light source lens 410 satisfies Equation 2. Therefore, the light refracted through the refraction surface 412 has uniform angular distribution in an upper area of the light source lens 410.

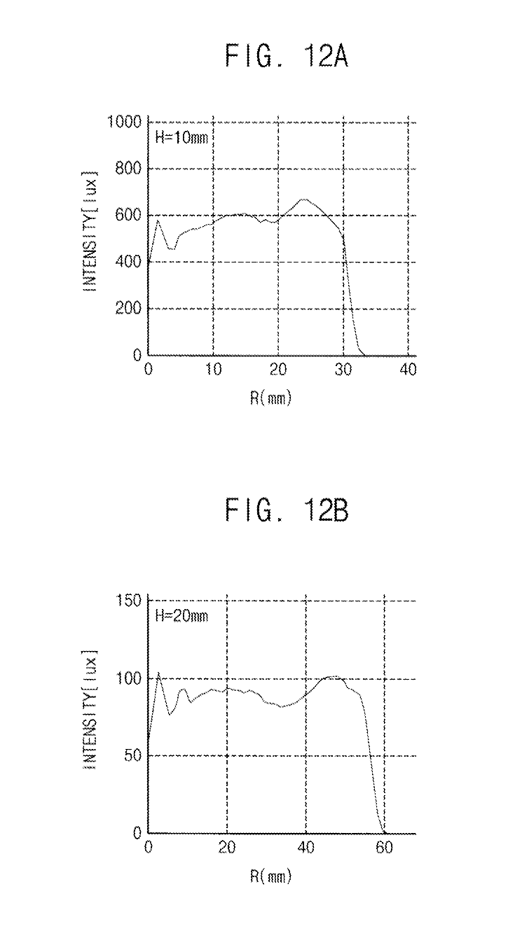

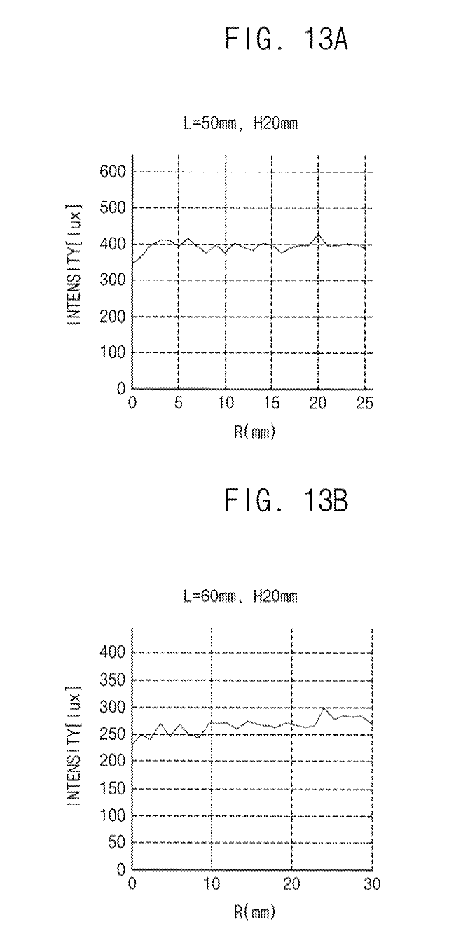

FIG. 11 is a cross-sectional view explaining a pathway of light from the light source module 400 of FIG. 9. FIGS. 12A and 1213 are graphs explaining illuminance in an upper area of the light source module 400 of FIG. 9. FIGS. 13A and 13B are graphs explaining illuminance in the upper area of the light source modules 400 when the backlight assembly includes a plurality of the light source modules 400.

[Referring to FIG. 11, the light at the central axis of the light source lens 410 advances upward without refraction. As the angle of the light with respect to the central axis of the light source lens 410 increases, the light is refracted through the refraction surface 412 of the light source lens 410 and is scattered. Therefore, the light has substantially uniform angular distribution in an upper area of the light source lens 410.

Referring to FIGS. 12A and 12B, a distribution of illuminance at distance R from the central axis of the light source lens 410 and at vertical distance H from the light source 430 is shown. When the vertical distance H from the light source 430 is about 10 mm, the distribution of the luminous intensity is approximately uniform for R values between about 0 mm and about 24 mm. When the vertical distance H from the light source 430 is about 20 mm, the absolute value of the luminous intensity is approximately uniform between about 0 mm and about 50 mm.

Accordingly, the light source 430 exhibits approximately uniform illuminance over a range of R values, even if the distance between the optical sheets 200 and light source 430 is decreased. Therefore, substantially uniform illuminance may be more effectively maintained while the total thickness of the backlight assembly is decreased. In addition, the backlight assembly may maintain an approximately uniform illuminance without a diffusion sheet, so that the optical sheets 200 need not necessarily include a diffusion sheet, thus further reducing the total thickness of the backlight assembly.

Referring to FIGS. 8, 13A and 13b, the backlight assembly may include a plurality of the light source modules 400. In this case, light emitted from the light sources overlaps above the light sources 430, so that illuminance is affected by the number of light sources 430. In the present example embodiment, since the backlight assembly includes a plurality of the light source modules 400, a distribution of illuminance according to a distance R from the central axis of the light source lens 410 is approximately uniform in an area which is disposed over the light source by a vertical distance H. Additionally, even if a distance between adjacent light source modules 400 is increased, or the number of the light source modules 400 is decreased, the illuminance may remain approximately uniform. In FIGS. 13A and 13B, L is a distance between adjacent light source modules 400. When the distance between the light source modules 400 increases from about 50 mm to about 60 mm, the absolute value of illuminance or luminous intensity is decreased, but the distribution of illuminance remains substantially uniform.

As illuminance may be kept substantially uniform with a reduced number of the light sources included in the backlight assembly, the total thickness of the backlight assembly may thus be decreased.

According to the present invention, a light source module includes a light source lens with a refraction surface having a concave portion near its central axis. The light source lens is shaped to refract light emitted from the light source such that the light is emitted in more uniform manner. Therefore, the total thickness of the backlight assembly and the number of light sources included in the backlight assembly may be reduced.

The foregoing is illustrative of the present disclosure and is not to be construed as limiting thereof. Although a few example embodiments of the present invention have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific example embodiments disclosed, and that modifications to the disclosed example embodiments, as well as other example embodiments, are intended to be included within the scope of the appended claims. Embodiments of the present invention are defined by the following claims, with equivalents of the claims to be included therein.

What is claimed is:

1. A light source lens comprising:
a refraction surface having a concave portion proximate to a central axis of a light source lens, the central axis passing through a light source coupled to the light source lens,
wherein an angular distribution function F(θ′) of a first light emitted from the light source and refracted at the refraction surface at least approximately satisfies
$$F ( {θ}^{′} ) ∝ \frac{1}{{cos}^{3} ( {θ}^{′} )} ,$$
where θ′ is a latitude angle of the first light refracted at the refraction surface with respect to the central axis.

2. The light source lens of claim 1, wherein the refraction surface has a substantially circular shape in a plan view and is substantially symmetric with respect to the central axis in a cross-sectional view, and
a first side of the refraction surface has an arc-shaped curve extending from a lowest position of the concave portion to an edge of the light source lens, with a highest position of the concave portion that is positioned at an angle between about 40° and about 45° with respect to the central axis in the cross-sectional view.

3. The light source lens of claim 1, wherein the refraction surface has a substantially circular shape in a plan view, and is substantially symmetric with respect to the central axis in a cross-sectional view, and a first side of the reflection surface with respect to the central axis in the cross-sectional view comprises:
an arc-shaped curve extending from a lowest position of the concave portion to a highest position of the concave portion that is positioned at an angle between about 40° and about 45° with respect to the central axis; and
a vertical line extending from the arc-shaped curve to an edge of the light source lens, oriented substantially parallel with the central axis, and positioned at an angle between about 40° and about 50° with respect to the central axis.

4. A light source module comprising:
a light source; and
a light source lens comprising a refraction surface having a concave portion proximate to a central axis of the light source lens, the central axis passing through the light source, the light source being coupled to the light source lens,
wherein an angular distribution function F(θ′) of a first light emitted from the light source and refracted at the refraction surface at least approximately satisfies
$$F ( θ ) = \frac{cos ( θ )}{π} ,$$
where θ′ is a latitude angle of the first light refracted at the refraction surface with respect to the central axis.

5. The light source module of claim 4, wherein the light source includes a light emitting diode.

6. The light source module of claim 4, wherein a refractive index of the light source lens is about 1.4.

7. The light source module of claim 4, wherein the light source is disposed on a bottom surface of the light source lens, and an angular distribution function F(θ) of the first light emitted from the light source at least approximately satisfies
$$F ( θ ) = \frac{cos ( θ )}{π} ,$$
where θ is a latitude angle of the first light emitted from the light source with respect to the central axis.

8. The light source module of claim 7, wherein the light source directly contacts the light incident surface.

9. The light source module of claim 8, wherein the refraction surface has a substantially circular shape in a plan view and is substantially symmetric with respect to the central axis in a cross-sectional view, and
a first side of the refraction surface has an arc-shaped curve extending from a lowest position of the concave portion to an edge of the light source lens, with a highest position of the concave portion that is positioned at an angle between about 40° and about 45° with respect to the central axis in the cross-sectional view.

10. The light source module of claim 9, wherein a height of the lowest position of the concave portion is between about 1.7 mm and about 2.0 mm, a height of the highest position of the refraction surface is between about 2.6 mm and about 2.8 mm, a radius of a circle which is a projection of the refraction surface in the plan view is between about 4.5 mm and about 5.5 mm, and the first side of the refraction surface has an arc-shaped curve defined by a plurality of curvature radiuses.

11. The light source module of claim 4, wherein the light source is spaced apart from a bottom surface of the light source lens, and an angular distribution function F(θ) of the first light incident to the light source lens at least approximately satisfies
$$F ( θ ) = {n}^{2} \frac{cos ( θ )}{π} ,$$
where θ is a latitude angle of the first light emitted from the light source with respect to the central axis and n is a refractive index of the light source lens.

12. The light source module of claim 11, wherein the refraction surface has a substantially circular shape in a plan view, and is substantially symmetric with respect to the central axis in a cross-sectional view, and a first side of the refraction surface with respect to the central axis in the cross-sectional view comprises:
an arc-shaped curve extending from a lowest position of the concave portion to a highest position of the concave portion that is positioned at an angle between about 40° and about 45° with respect to the central axis; and
a vertical line extending from the arc-shaped curve to an edge of the light source lens, oriented substantially parallel with the central axis, and positioned at an angle between about 40° and about 50° with respect to the central axis.

13. The light source module of claim 12, wherein a height of the lowest position of the concave portion is between about 3.2 mm and about 3.7 mm, a height of the highest position of the refraction surface is between about 4.5 mm and about 5.0 mm, and a radius of a circle which is a projection of the refraction surface in the plan view is between about 4.5 mm and about 5.5 mm.

14. A backlight assembly comprising:
a light source module comprising:
a light source, and
a light source lens comprising a refraction surface having a concave portion proximate to a central axis of the light source lens, the central axis passing through the light source, the light source being coupled to the light source lens,
wherein an angular distribution function F(θ′) of a first light emitted from the light source and refracted at the refraction surface at least approximately satisfies
$$F ( {θ}^{′} ) ∝ \frac{1}{{cos}^{3} ( {θ}^{′} )} ,$$
where θ′ is a latitude angle of the first light refracted at the refraction surface with respect to the central axis;
one or more optical sheets adjacent to the light source lens; and
a receiving container receiving the light source, the light source lens and the optical sheets.

15. The backlight assembly of claim 14, wherein the light source includes one or more light emitting diodes.

16. The backlight assembly of claim 14, wherein the light source and the light source lens are disposed under the optical sheets.
